(19) United States
(12) Patent Application Publication
(10) Pub. No.: US 2005/0007420 A1
(43) Pub. Date: Jan. 13, 2005

(54) Ink container and ink container holder

(75) Inventors: Masashi Ogawa, Kawasaki-shi (JP); Masanori Takenouchi, Yokohama-shi (JP); Yasuo Kotaki, Yokohama-shi (JP); Wataru Takahashi, Kawasaki-shi (JP); Hiromasa Anma, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/859,112

(22) Filed: Jun. 3, 2004

(30) Foreign Application Priority Data
Jun. 6, 2003 (JP) 162932/2003(PAT.)

(51) Int. Cl. B41J 2/14

(52) U.S. Cl. 347/50

(57) ABSTRACT

An ink container holder to which a plurality of ink containers are mountable includes ink receiving openings for receiving inks supplied from ink supply ports of ink containers, and contact portions electrically connectable with contacts of storing devices provided on the ink containers, respectively. Distances between the contact portions and corresponding ink receiving openings and different depending on kinds of inks contained in the ink containers.

### FIELD OF THE INVENTION AND RELATED ART

The present invention relates to an ink container and an ink container holder.

As an ink container, for example, a rotation mounting type ink container as described in U.S. Pat. No. 5,619,239 has been known. This ink container is particularly suitable for a recording apparatus of a space-saving type and is mounted in such a manner as shown in FIGS. 10(a) to 10(d). More specifically, an ink container 100 containing ink in its main body is mounted in an ink container holder 120 having a recording head 110 with a rotation thereof, and the ink container holder 120 is mounted to a carriage of a serial scanning type recording apparatus. The ink inside the ink container 100 is supplied from an ink supply port 100A at a bottom surface of the ink container 100 to the recording head 110 through an ink receiving pipe 121 disposed in the holder 120. The ink receiving pipe 121 is provided with a filter at its top surface.

At the time of mounting of the ink container 100, first of all, the ink container 100 is inserted into an opening portion of the holder 120 as shown in FIG. 10(a). By doing so, a front surface of the ink container 100 and a rib 120A of the holder 120 contact each other, and a curved corner portion 100B of the ink container 100 abuts against an inner wall surface of the holder 120. As a result, the ink container 100 is moved downward in a direction of an arrow. During the downward movement, as shown in FIG. 10(b), a curved corner portion 100C at a top surface of the ink container 100 abuts against an inner surface of the holder 120, so that the ink receiving pipe 121 enters the ink supply port 100A. Thereafter, the ink container 100 is rotated about its front portion while being moved toward the rear (leftward in the figure) at its rear surface. As a result, as shown in FIG. 10(c), the top surface 100C of the ink container 100 abuts against an extended portion 122 provided to the holder 120. At a lower surface of the extended portion 122, a curved area 122A and a horizontal area 122B are provided. The top surface 100C is, after abutting against the curved area 122A as shown in FIG. 10(c), moved to the horizontal area 122B by further rotation operation of the ink container 100 as shown in FIG. 10(d). In such a state shown in FIG. 10(d), by the action of reaction force of an elastic member 123 which is disposed at an inner bottom surface of the holder 120 and is pressed by a bottom surface of the ink container 100, the ink container 100 is fixed. Accordingly, it is possible to fix the ink container 100 in a very small space.

U.S. Pat. No. 6,302,535 has disclosed an ink container, provided with a storing device, which is different in rotation scheme from the ink container described in U.S. Pat. No. 5,619,239 and is mounted in an ink container holder by its own rotation. Further, when the ink container is mounted in the holder, a contact (point) of the ink container and a contact (point) of the holder are connected to each other. As a result, through these contacts, the storing device of the ink container is electrically connected to a recording apparatus. In the storing device, it is possible to store intrinsic information of the ink container (provided with the storing device) in addition to data regarding a residual amount of ink in the ink container. The position of the contact on the ink container side is set to be a certain position at a lower end portion of a side surface of the ink container, irrespective of kinds of ink contained in the ink container.

Further, such an ink container provided with a storing device has also been described in Japanese Laid-Open Patent Application No. Hei 10-323995 and U.S. patent application Publication No. US2001/0026301 A1. These ink containers, similarly as in that described in U.S. Pat. No. 6,302,535, have a contact located t a certain position on the ink container side, irrespective of the species of ink contained in the ink containers.

In the case where the rotation mounting type ink container is provided with the storing device, the position of the contact on the ink container side affects as follows with a contact on the holder side.

FIGS. 11(a) and 11(b) are explanatory views in the case where a contact 101 on an ink container side is disposed at different positions of a rotation mounting type ink container 100 provided with a storing device and having a rotation center O. The rotation center O is a center of rotation of the ink container 100 when the ink container 100 is mounted in and demounted from an ink container holder. The rotation center is located in the vicinity of a bottom surface of the ink container 100, and at the bottom surface, an ink supply port 100A is formed. In order to stably effect an electrical connection of the storing device, it is desirable that a contact pressure between the contact 101 on the ink container side and a contact on the holder side is set to a large value. The position of the contact 101 (on the ink container side) is set to a lower portion of the ink container 100 in the case of FIG. 11(a) and an upper portion of the ink container 100 in the case of FIG. 11(b). In these cases shown in FIGS. 11(a) and 11(b), when an identical mounting force is applied to the ink container in a direction of an arrow A, a resultant contact pressure in the case of FIG. 11(a) can be made larger than that in the case of FIG. 11(b). Accordingly, from the viewpoint of ensuring the contact pressure with reliability, it is preferable that the contact on the ink container side is disposed at the lower portion of the ink container 100. On the other hand, in the case of FIG. 11(a) the contact 101 is located close to the ink supply port 100A, a possibility of contamination of the contact 101 with ink is increased by that much.

More specifically, to the lower portion or the bottom surface of the ink container 100, ink scattered at the time of mounting and demounting of the ink container 100 and flying ink mist during a recording operation are liable to be attached. Further, by a capillary force generated at an edge portion in the holder, there is a possibility that ink attached to the inside of the holder is raised to the position of the contact 101. In the case where the ink is attached to the contact 101, a resistance value of a connection circuit of the storing device is changed to cause glitch (malfunction) of the storing device. Further, if the storing device has a plurality of contacts (contact points) 101, there is a possibility that electrical short circuit is caused to occur. Further, by evaporation of a volatile component of the ink attached to the contact 101, the ink is increased in viscosity and can prevent electrical contact of the contact 101. In the conventional ink containers, as described above, the contact on the ink container side is set to the certain (predetermined) position regardless of the species of ink contained in the ink container used. For this reason, in view of a contradictory relationship between ensuring of the contact pressure and avoidance of influence of contamination with ink, the position of contacts are set to be a predetermined common position with respect to all the ink containers containing various inks.

### SUMMARY OF THE INVENTION

The present invention has accomplished based on finding that the influence of ink contamination on the contact (point) is different depending on the kinds of inks.

An object of the present invention is to provide an ink container holder capable of setting an optimum position of electrical contacts (contact points) thereof in view of a possibility of ink deposition thereto.

Another object of the present invention is to provide ink containers incorporated in the ink container holder.

According to the present invention, there is provided an ink container holder to which a plurality of ink containers are mountable, comprising:
ink receiving openings for receiving inks supplied from ink supply ports of ink containers, and
contact portions electrically connectable with contacts of storing devices provided on the ink containers, respectively,
wherein distances between the contact portions and corresponding ink receiving openings and different depending on kinds of inks contained in the ink containers.

According to the present invention, there is also provided an ink container holder to which a plurality of ink containers are mountable, comprising:
ink receiving openings for receiving inks supplied from ink supply ports of ink containers, and
contact portions electrically connectable with contacts of storing devices provided on the ink containers, respectively,
wherein distances between the contact portions and corresponding ink receiving openings and different depending on the number of ink supply ports for supplying inks from the ink containers to the ink container holder.

According to the present invention, there is further provided an ink container detachably mountable to a recording apparatus to which a plurality of ink containers are mountable, comprising:
an ink supply port for supplying ink from an inside to an outside of said container, and
a storing device, disposed at a surface of a main body of said container, having a contact portion for being electrically connectable with the recording apparatus,
wherein a distance between said contact portion and said ink supply port is determined depending on a physical property of the ink contained in the main body of said container.

According to the present invention, there is further provided an ink container a plurality of which are mountable to a holder of a recording apparatus by substantially rotational operation under the action of a pressing force applied from an elastic member and an extended portion which are disposed opposite to the holder, the ink container comprising:
an ink supply port at a bottom surface, and
a storing device having a contact electrically connected to the holder at its rear surface,
wherein a distance between the contact and the ink supply port is changed depending on the pressing force acting on the ink container.

In the above described ink container holders and ink containers, depending on the species of ink, the number of ink supply ports, or the pressing force acting on the ink container, the position of the contact portion of the ink container holder or the position of the contact of the ink container is appropriately set. As a result, it becomes possible to minimize a possibility that the ink is deposited onto the contact portion or the contact. Further, it is possible to ensure a reliability of the contact portion or the contact and thus a function of the storing device provided to the ink container can be performed with reliability.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a sectional view of an ink container holder in which an ink container according to First Embodiment of the present invention is mounted.

FIG. 2 is a perspective view of the ink container shown in FIG. 1 as seen from a lower side thereof.

FIG. 3 is an enlarged side view of an extended portion of the ink container holder shown in FIG. 1.

FIGS. 4(a), 4(b) and 4(c) are explanatory views of a mounting operation of the ink container in the ink container holder shown in FIG. 1.

FIG. 5 is an explanatory view of a capillary force of ink at an image edge portion (corner) of the ink container holder shown in FIG. 1.

FIG. 6 is a view showing a rear surface of a black ink container and a color ink container used in First Embodiment of the present invention.

FIG. 7 is a view for illustrating a positional relationship between the black ink container and the color ink container, shown in FIG. 6, at their rear surfaces when they are mounted in a common ink container holder.

FIG. 8 is a sectional view of an ink container holder in which an ink container used in Second Embodiment of the present invention is mounted.

FIG. 9 is a view for illustrating a positional relationship between a black ink container and a color ink container used in Third Embodiment at their rear surfaces when they are mounted in a common ink container holder.

FIGS. 10(a), 10(b), 10(c) and 10(d) are explanatory views of an operation for mounting a conventional ink container in an ink container holder.

FIGS. 11(a) and 11(b) are views for illustrating an influence of a positional relationship between a rotation center and a contact point of an ink container.

### DETAILED DESCRIPTION OF THE PREFERRED EMBODIMENTS

Hereinbelow, embodiments of the present invention will be described with reference to the drawings.

### First Embodiment

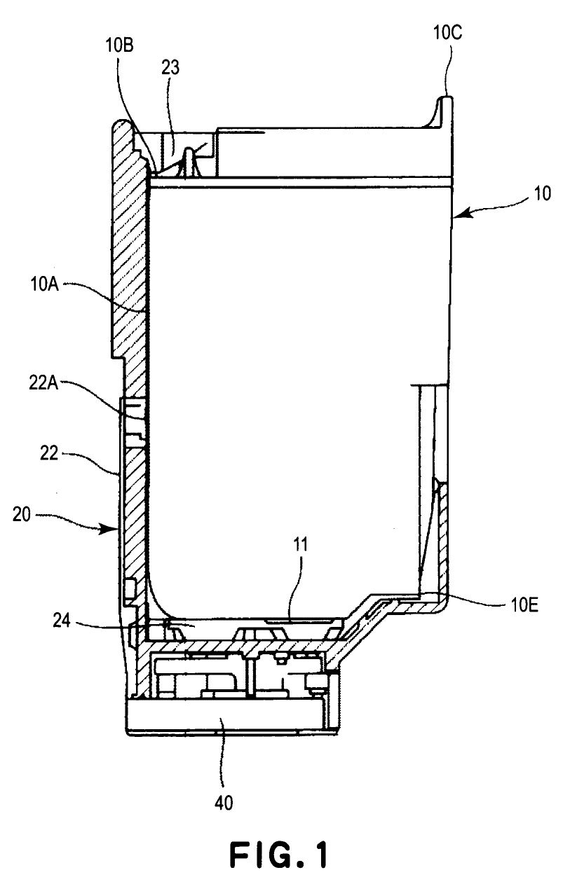

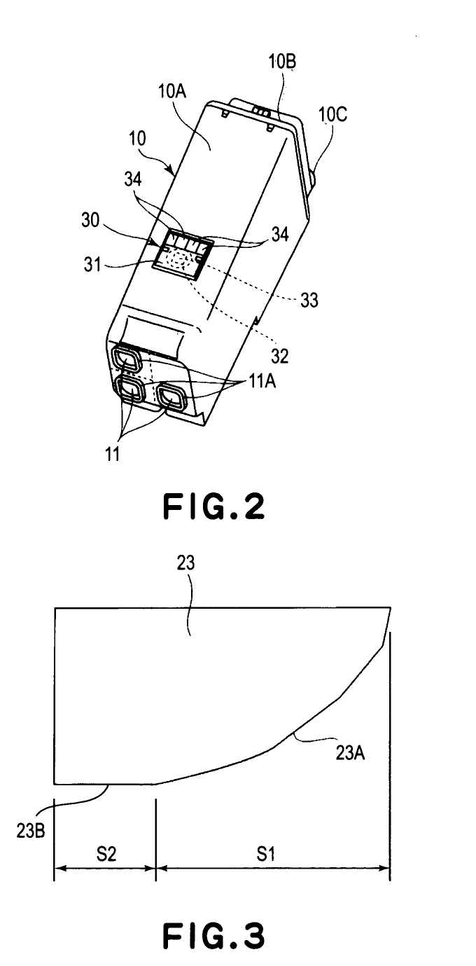

FIG. 1 is a sectional view of an ink container holder 20 in which an ink container 10 according to this embodiment, and FIG. 2 is a perspective view of the ink container 10 as seen from its bottom surface side.

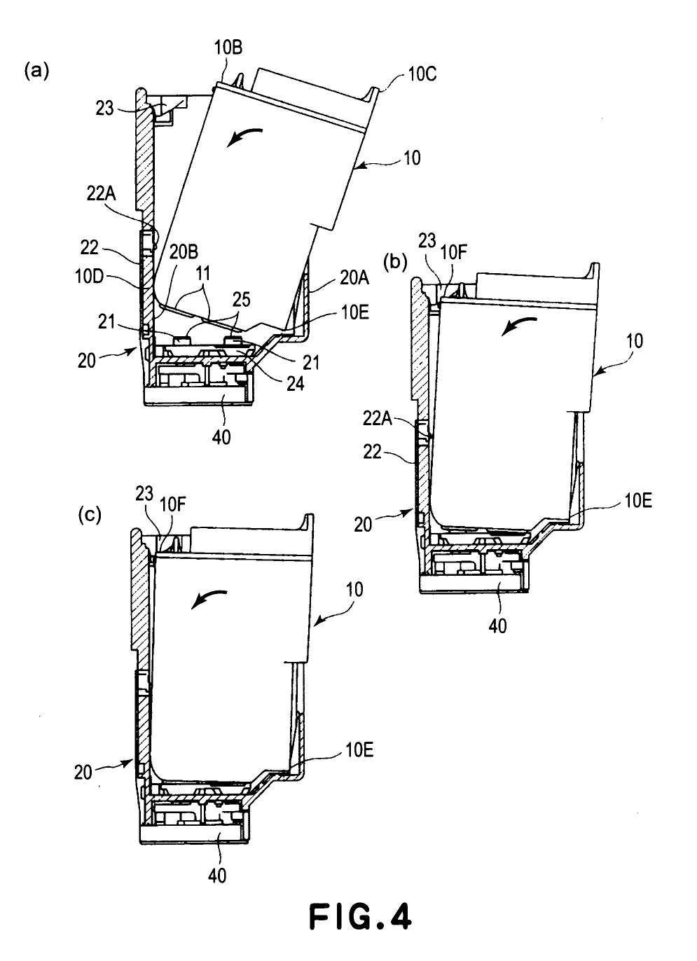

Referring to these figures, at a rear surface 10A (a left side surface on the figures) of the ink container 10, a storing device unit 30 is provided, and a recording head 40 is provided to the holder 20. The holder 20 to which the ink container 10 is mounted in detachably mounted to a carriage of a serial scanning type recording apparatus. The ink contained in the ink container 10 is supplied from an ink supply port 11 located at a bottom surface of the ink container 10 to the recording head 10 through an ink receiving pipe 21 (shown in FIG. 4) disposed inside the holder 20. The recording head of a serial scanning type alternately repeats an operation of ejecting ink from the recording head on the basis of the recording head while being moved in a main scanning direction together with the carriage and a conveyance operation of conveying a medium to be recorded (recording medium) in a sub scanning direction perpendicular to the main scanning direction. By doing so, an image is successively formed on the recording medium.

On a rear side of a double-surface wiring substrate 31 of the storing device unit 30, a storing device 33 sealed with a sealing agent 32 is mounted, and on a front surface of the substrate 31, a contact (point) 34 connected to the storing device 33 is formed. The holder 20 is provided with a relay substrate 22 electrically connected to the recording head 40. At an inner surface of the relay substrate 22, a brush-like contact portion 22A is provided opposite to the contact 34. Further, at an outer surface of the relay substrate 22, an outer contact portion (not shown) is formed opposite to a contact, on the carriage side, which is connected to a control unit of the recording apparatus. Accordingly, the storing device 33 and the recording head 40 are electrically connected to the control unit of the recording apparatus through the relay substrate 22. In the storing device 33, for example, it is possible to store intrinsic information of the ink container 10 (provided with the storing device 33) in addition to data regarding a residual amount of ink in the ink container 10.

The holder 20 is provided with an extended portion 23 for pressing a top surface 10B of the ink container 10 and an elastic member 24 contacting a rib 11A surrounding the ink supply port 11. At a lower surface of the extended portion 23, as shown in FIG. 3, a curved surface 23A in a curved area S1 and a planar surface 23B in a horizontal area S2 are formed. The curved area S1 is created in order to guide the ink container 10 at the time of effecting mounting and demounting of the ink container 10, and the horizontal area S2 is created in order to fix the ink container 10. An ink receiving opening formed at an upper surface of the ink receiving pipe 21 is provided with a filter 24 (shown in FIG. 4).

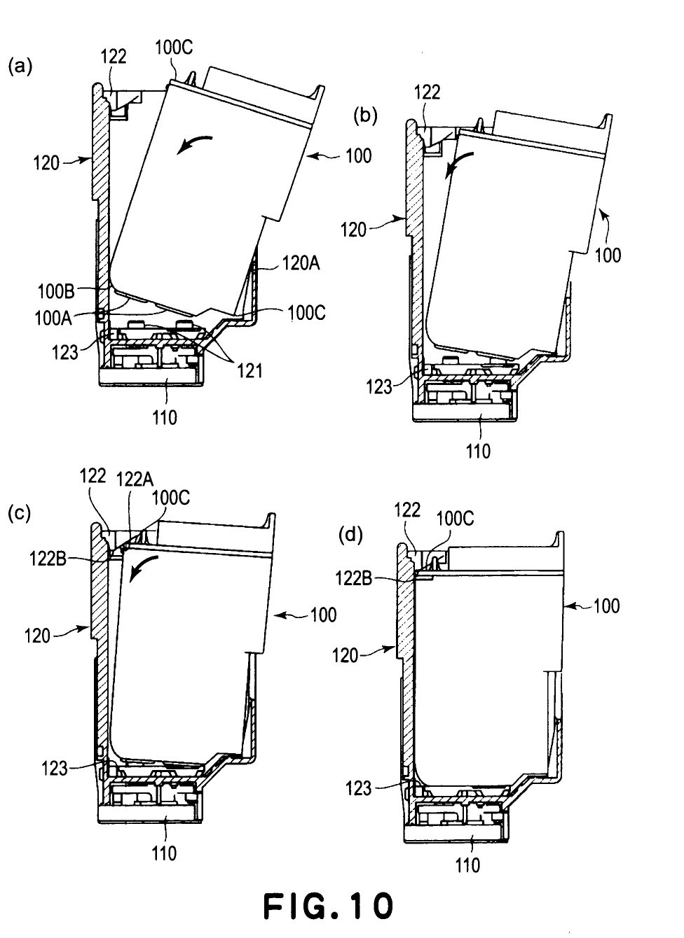

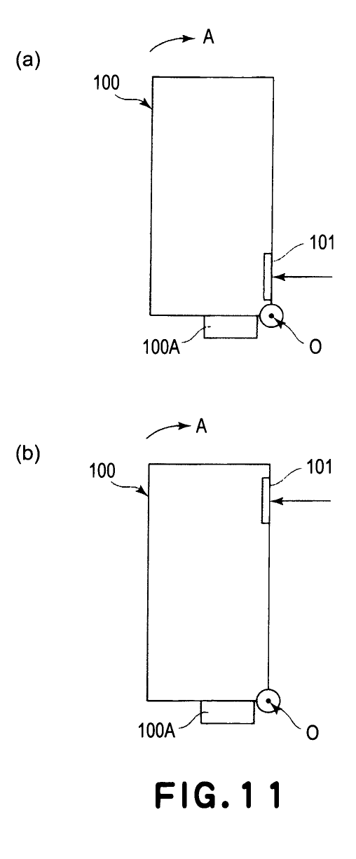

The ink container 10 is mounted in the holder 21 while being rotated similarly as in the conventional ink container 100 described above with reference to FIGS. 10(a) to 10(d). More specifically, a user presses a front top surface 10C of the ink container 10 after inserting the ink container 10 into the holder 20, whereby the ink container 10 contacts a rib 20A provided at a front surface of the holder 20 and at the same time, a curved corner portion 10D of the ink container 10 abuts against an inner wall surface 20B of the holder to be moved downward. During the downward movement of the ink container 10, a curved corner portion 10E located at the front surface of the ink container 10 abuts against the inner surface of the holder 20, so that the ink receiving pipe 21 enters the ink supply port 11. Then, the ink container 10 is rotated in a direction of an arrow and a top surface 10F of the ink container 10 abuts against the extended portion 23 provided to the holder 20 as shown in FIG. 4(b). The extended portion 23 regulates a rotation track of the ink container 10. By further rotation of the ink container 10, as shown in FIG. 4(c), the top surface 10F of the ink container 10 is moved from the curved area S1 to the horizontal area S2 of the extended portion 23. At that time, the elastic member 24 provided at the inner bottom surface of the holder 20 and the rib 11A provided so as to surround the ink supply port 11 of the ink container 10 overlap with each other (on the figure), whereby a reaction force of the elastic member 24 s generated to urge the ink container in the arrow direction. As a result, the ink container 10 is fixed in the holder 20 as shown in FIG. 1.

As described above, by mounting the ink container 10 in the holder 20, the contact 34 and the contact portion 22A contact and are electrically connected to each other. Further, by mounting the holder, in which the ink container 10 is mounted, to the carriage of the recording apparatus, the storing device 33 and the recording head 40 are connected to the control unit of the recording apparatus through the relay substrate 21. The recording head 40 ejects the ink, supplied from the ink container 10, from an ink ejection port by driving the storing device on the basis of a drive signal from the control unit of the recording apparatus. As the storing device, it is possible to use an electrothermal converter (heater) or a piezoelectric element. In the case of using the electrothermal converter, it is possible to eject the ink from the ink ejection port by utilizing bubble formation energy generated by ink bubbles created by heat generation of the electrothermal converter.

The contact 34 and the contact portion 22A are designed to contact each other when the top surface 10B is moved in the horizontal area S2 of the extended portion 23 at the time of rotation mounting of the ink container 10. On the other hand, when the ink container 10 is removed or demount from the holder 20, the ink container 10 is rotated about its rear bottom portion in a direction opposite from the arrow direction shown in FIGS. 4(a) to 4(c) after the physical contact between the contact 34 and the contact portion 22A is removed, whereby the top surface 10B of the ink container 10 is moved from the horizontal area S2 to the curved area S1 of the extended portion 23. When the ink container 10 is mounted in or demounted from the holder 20, at the surface of the filter 25 provided at an upper portion of the ink receiving pipe 21, a meniscus of the ink is formed in some cases, so that there is a possibility of ink deposition in the vicinity of the ink receiving pipe 21 by fine vibration impact. Further, a plastic material used for the ink container 10 is electrically charged to adsorb the ink mist scattered inside the recording apparatus in some cases.

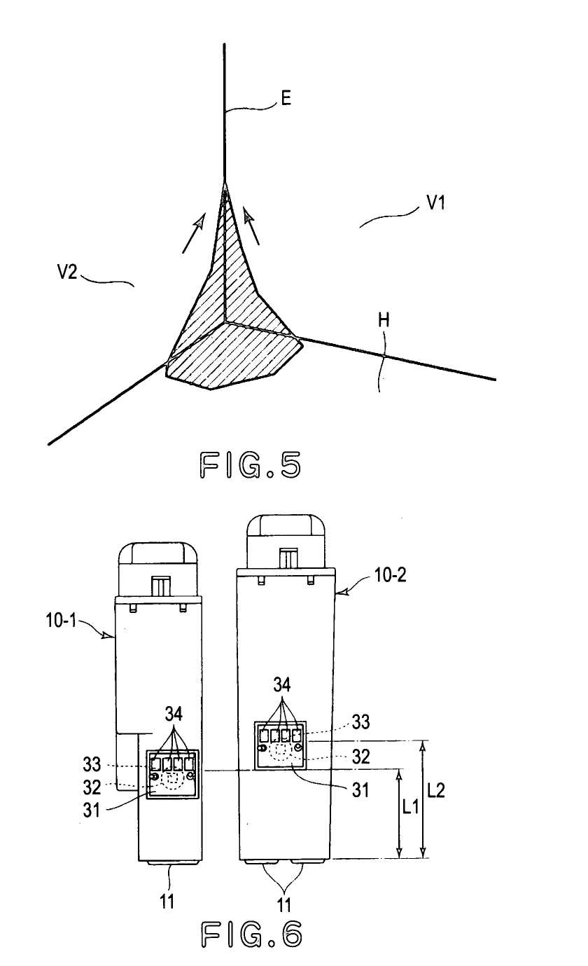

The ink attached to the inside of the holder is in an almost spherical state in the case where an external force is not exerted thereon. However, as shown in FIG. 5, by a capillary force generated at an edge portion E created in the holder 20 by a bottom surface H and side surfaces V1 and V2, an equilibrium state of the ink attached to the inside of the holder 20 is broken. As a result, a force of raising the ink toward the upper portion of the holder 20 in a direction of arrows, i.e., in a direction toward the contact 34 and the contact portion 22A, is exerted. The capillary force varies depending on the species of the ink contained in the ink container 10, so that a surface tension as a physical property of the ink largely affect the capillary force. The edge portion E can also be created on the ink container 10 if the ink container 10 has some particular shapes.

In this embodiment, the ink container 10, a black container 10-1 containing a topping type black ink and a color container 10-2 containing penetration type three color inks of cyan, magenta and yellow are used (FIG. 6). A color material of the topping type ink is liable to be located at the surface of the recording medium, and a color material of the penetration type ink is liable to penetrate into the recording medium. The color container 10-2 has the same structure as the ink container 10 described above but contains separately a cyan ink, a magenta ink, and a yellow ink and supplies their inks independently from an associated ink supply port 11. On the other hand, the black container 10-1 also has the same structure as the above described ink container 10. However, the black container 10-1 has a single ink supply port 11 from which the black ink contained in the black container 10-1 is supplied. The ink container holder 20 is provided with a mounting portion capable of independently mounting therein the black container 10-1 and the color container 10-2, and further provided with a recording head 40 capable of ejecting the inks of black, cyan, magenta, and yellow. A surface tension of the topping type black ink is larger than those of the penetration type color inks. For this reason, the ink raising force on the basis of the capillary force as shown in FIG. 5 is liable to be exerted on the color inks having surface tensions smaller than the black ink. In other words, a possibility that the ink contained in the color container 10-2 is attached so as to be close to the contact portion 22A and the contact 34 is high compared with the case of the black container 10-1. Accordingly, in this embodiment, as shown in FIG. 6, a distance L2 between the ink supply port 11 and the contact 34 of the color container 10-2 is set to about 25 mm which is about 5 mm longer than a distance L1 between the ink supply port 11 and the contact 34 of the black container 10-1. Further, in correspondence with the positions of these contacts 34, corresponding positions of the contact portions 22A of the holder 20 are similarly set.

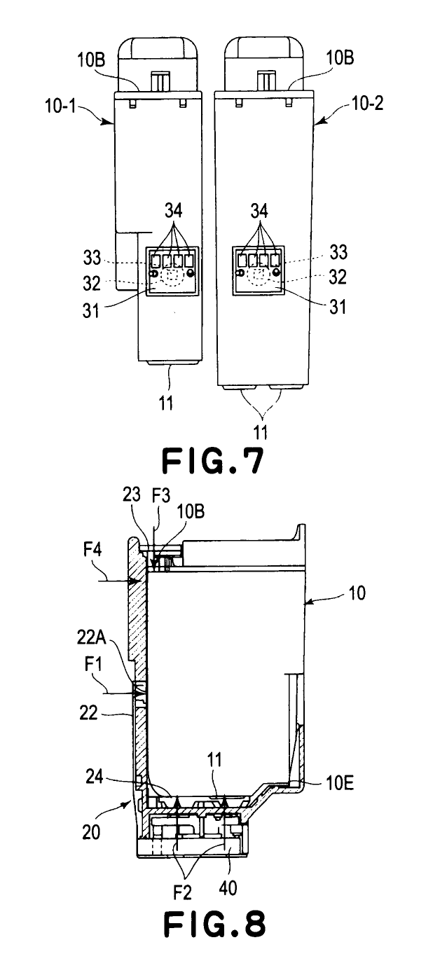

Further, in this embodiment, the contacts 34 of the ink containers 10-1 and 10-2 is located at an identical level when the ink containers 10-1 and 10-2 are mounted in a common holder 20, and the top surfaces 10B of the ink containers 10-1 and 10-2 are positionally aligned at an identical level by the extended portion 23. For this reasons, the ink containers 10-1 and 10-2 create a positional relationship therebetween as shown in FIG. 7 when they are mounted in the holder 20, so that the contacts 34 and the storing devices 33 of the ink containers 10-1 and 10-2 are located at identical levels, respectively. Further, positions of the ink receiving pipes for the black and color inks are set depending on the corresponding heights of the ink supply ports 11 of the ink containers 10-1 and 10-2, respectively. Further, positions of the ink ejection ports for ejecting the black ink and the color inks of the recording head are located on the same polar surface. The positions of the contacts 34 and the contact portions 22A are optimized depending on physical properties of the inks, the material of the holder 20, the shape of the edge portion E, etc., i.e., depending on the possibility of ink deposition to the contacts 34 and the contact portions 22A.

### Second Embodiment

FIG. 8 is a sectional view for illustrating on this embodiment.

When the ink container 10 is mounted in the ink container holder 20, a reaction force F1 from the wiring substrate 31 is exerted on the contact 34 of the ink container 10. By the reaction force F1, moment acts in a direction of removing the ink container 10 from the holder 20. Further, with an increasing distance between the corner portion 10E, as the rotation center at the time of mounting the ink container 10, and the contact 34, moment acting the corner portion 10E becomes larger. As a result, a possibility that mounting failure of the ink container 10 is caused to occur is increased. For this reason, it is desirable that the position of the contact 34 is close to the corner portion 10E.

On the ink container 10 fixed in the holder 20, pressing forces (reaction forces F2 and F3) are exerted, so that a removing force F4 against these pressing forces is required in order to remove the ink container 10 from the holder 20. More specifically, in a fixed state of the ink container 10, by an abutting force between the rib 11A of the ink supply port 11 disposed at the bottom surface of the ink container 10 and the elastic member 24 provided in the holder 20 and a pressing force of the ink receiving pipe 21 of the holder 20 against a pressure contact structure created inside the ink container 10, a reaction force F2 acts the ink container 10. Further, a reaction force F3 generated by the contact between the top surface 10B of the ink container 10 and the extended portion 23 acts the ink container in a direction substantially opposite to the direction of the reaction force F2.

The reaction force F2 varies depending on an amount of interaction (interaction amount) between the rib 11A disposed to surround the ink supply port 11 (FIG. 2) and the elastic member 24, an interaction amount of the ink receiving pipe 21 with the pressure contact structure created in the ink supply port 11, and the number of the ink supply port 11. In the case where the former interaction amount is small, the ink supply port 11 is open to air in a state that the ink container 10 is mounted in the holder 20, i.e., an actual operation state by the use. As a result, the ink contained in the ink container 10 is evaporated to decrease in amount thereof usable in recording in some cases. For this reason, the interaction amount which is not less than a predetermined value is required.

With respect to the latter interaction amount, it is necessary to set a contact area and an interaction amount required for supplying the ink from the ink container 10 to the ink receiving pipe 21. In the case where the interaction amount is small, there is a possibility that the ink cannot be supplied from the ink container 10 to the ink receiving pipe 21.

A strength of the removing force F4 corresponds to a mounting force required at the time of mounting force required at the time of mounting the ink container 10 in the holder 20. When the ink container 10 is mounted to and demounted from the holder 20, in some cases, the ink is scattered at the time of separating the ink supply port 11 from the ink receiving pipe 21. As a result, the scattering possibility becomes higher as the mounting and demounting force of the ink container 10 becomes larger.

In the case where a plurality of ink containers 10 are mounted in the same holder 20, and an interaction amount between the ribs 11A and the elastic member 24 or an interaction amount of the ink receiving pipe 21 is different every ink container, the reaction forces F2 and F3 acting the ink container 10 having a larger interaction amount becomes larger. As a result, a larger removing force F4 is required at the time of removing the ink container 10, so that a possibility that the scattered ink is attached onto the storing device 33 fixed at the surface of the ink container 10 becomes higher. Accordingly, depending on an interaction amount every ink container 10 to be mounted in the same holder 20, a difference in ink deposition possibility arises. However, with respect to the ink container 10 requiring a larger removing force F4, moment exerted by the reaction force F1 from the contact is set to be larger than the removing force F4 at a lower level, i.e., a distance between the contact and the ink supply port is set to be longer, whereby it is possible to consequently achieve a mounting and demounting mechanism having a less possibility of deposition of ink onto the storing device without excessively reducing the contact pressure and the interaction amount of the ribs of the ink supply port and deteriorating an electrically conducting function between the contact and the contact portion of the holder.

Further, the reaction forces F2 and F3 are increased in proportion to a length of the rib 11A of the ink supply port 11. A monocolor ink container containing a monocolor ink ordinarily has one ink supply port, and an ink container for a plurality of colors containing plural color inks (e.g., four color inks) requires an ink supply port every species of ink. For example, an ink container containing four color inks requires an ink supply port for each ink species, i.e., four ink supply ports. As a result, the sum of lengths of the four ink supply ports (for four colors) becomes longer, so that the reaction forces and the removing force F4 also become larger. Accordingly, a possibility of deposition of scattered ink onto the storing device 33 fixed at the surface of the ink container 10 becomes higher. As a result, a difference in ink deposition possibility arises depending on a (total) length of the ink supply port of the ink container 10 mounted in the same holder 20. However, with respect to the ink container requiring a larger removing force F4, moment exerted by the reaction force F1 from the contact is set to be larger than the removing force F4 at a lower level, i.e., a distance between the contact and the ink supply port is set to be longer, whereby it is possible to consequently achieve a mounting and demounting mechanism having a less possibility of deposition of ink onto the storing device without excessively reducing the contact pressure and the interaction amount of the ribs of the ink supply port and deteriorating an electrically conducting function between the contact and the contact portion of the holder.

In this embodiment, the black container 10-1 only contains a black ink, and the color container 10-2 contains three color inks of yellow, magenta and cyan. At a bottom surface of the color container 10-2, there ink supply ports 11 are provided. An influence of an interaction amount of the ink receiving pipe 21 (FIG. 4) with a pressure contact structure provided inside the ink supply port 11 is substantially identical with respect to the ink container 10-1 and the color container 10-2 (FIGS. 6 and 7).

Further, a strength of the reaction force F3 is proportional to a contact area between the top surface 10B of the ink container 10 and the extended portion 23. The contact area is substantially identical with respect to the black container 10-1 and the color container 10-2. Accordingly, the removing forces F4 for the black container 10-1 and the color container 10-2 are largely different by the influence of the interaction amount between the rib 11A surrounding the ink supply port 11 (FIG. 2) and the elastic member 24, i.e., the length of the rib 11A. In this embodiment, the length of the rib 11A of the single ink supply port 11 of the black container 10-1 is about 38 mm. On the other hand, the color container 10-2 contains three color inks, so that it is necessary to provide three ink supply ports as described above. The total length of the three ribs 11A is 67 mm. Accordingly, in order to demount the color container 10-2 from the holder 20, it is necessary to apply a removing force F4 larger than that for the black container 10-1.

The color container 10-2 is removed by the removing force F4 larger than that for the black container 10-1, so that ink liable to be scattered by that much when the ink supply port 11 and the ink receiving pipe 21 are separated from each other. In other words, an ink deposition possibility to the contact portion 22A and the contact 34 is higher in the case of the color container 10-2 compared with the black container 10-1.

Accordingly, in this embodiment, the distance between the contact 34 and the ink supply port 11 in the color container 10-2 was set to be about 5 mm longer than that in the black container 10-1. Further, positions of the contact portions 22A on the holder 20 side were also similarly set in correspondence with the positions of the contacts 34 of these color and black containers 10-2 and 10-1. By doing so, it was possible to suppress a possibility of ink deposition onto the contact 34 of the color container 10-2 and the contact portion 22A at a low level. Further, even when the distance between the contact 34 of the color container 10-2 (and the contact portion 22A) and the ink supply port 11 was made large as in this embodiment, the color container 10-2 was not removed by the reaction force F1.

### Third Embodiment

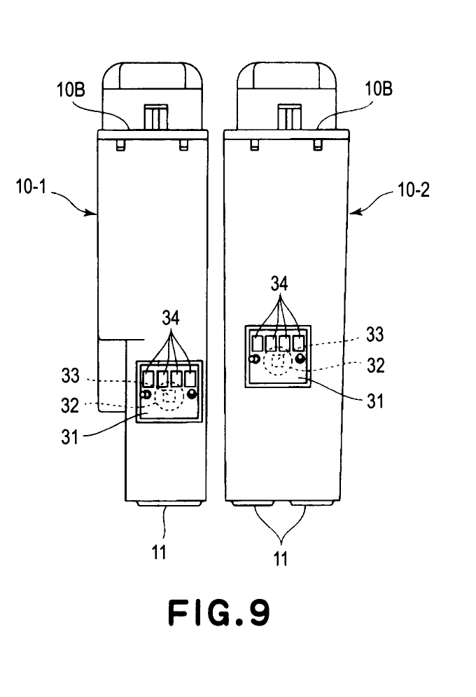

In this embodiment, the black container 10-1 and the color container 10-2 are placed in a state providing a positional relationship therebetween as shown in FIG. 9 when they are mounted in the common holder 20. More specifically, in the mounting state of the ink containers 10-1 and 10-2, their contacts 34 and storing device 33 are located at positions having different heights.

### Other Embodiments

The ink container and the recording head may be integrally supported to constitute an ink jet cartridge. In this case, the ink jet cartridge may be mounted in a holder provided to a carriage of the recording apparatus. Further, in the case where different inks are individually contained in different ink containers, respective positions of contacts are optimally set every ink container depending on the species of ink and a pressing force of the ink container.

Further, positions of the contacts of the ink containers and the contact portions of the holder may be optimally set depending on various physical properties or the like of ink used, in addition to a surface tension of the ink and the pressing force of the ink container. The positions of the contacts and the contact portions may be set depending on ink deposition possibility with respect to the contacts of the ink containers and the contact portions of the holder, thereby to suppress the ink deposition possibility at a low level.

Further, in the ink container used in the present invention, ink is refilled through the ink supply port 11 or an ar communication port (not shown) after the ink contained in the ink container is consumed, whereby it is possible to reuse the ink container. Alternatively, it is also possible to effect ink injection by forming an opening to a housing of the ink container with a tool such as a drill or the like.

1. An ink container holder to which a plurality of ink containers are mountable, comprising:
ink receiving openings for receiving inks supplied from ink supply ports of ink containers, and
contact portions electrically connectable with contacts of storing devices provided on the ink containers, respectively,
wherein distances between said contact portions and corresponding ink receiving openings are different depending on kinds of inks contained in the ink containers.

2. An ink container detachably mountable to a recording apparatus to which a plurality of ink containers are mountable, comprising:
an ink supply port for supplying ink from an inside to an outside of said container, and
a storing device, disposed at a surface of a main body of said container, having a contact portion for being electrically connectable with the recording apparatus,
wherein a distance between said contact portion and said ink supply port is determined depending on a physical property of the ink contained in the main body of said container.

3. A container according to claim 2, wherein the physical property of the ink is a surface tension.

4. A container according to claim 3, wherein the distance between said contact portion and said ink supply port is longer as the surface tension of the ink contained in the main body of said container is relatively smaller.

5. A container according to claim 2, wherein the ink is contained in said container.

6. An ink injection method comprising a step of injecting ink into an ink container according to claim 2.

7. An ink container for being mounted to a holder, of a recording apparatus, to which a plurality of ink containers are mountable, comprising:
an ink supply port, and
a storing device having a contact portion for being electrically connected to the holder,
wherein a distance between said contact portion and said ink supply port is determined depending on a force of releasing said container from the holder.

8. A container according to claim 7, wherein the distance between said contact portion and said ink supply port with respect to an ink container having a plurality of ink supply ports is longer than that with respect to an ink container having a single ink supply port.
